(19) United States
(12) Patent Application Publication
(10) Pub. No.: US 2008/0235902 A1
(43) Pub. Date: Oct. 2, 2008

(54) Device for Cleaning the Filter Pipes Used to Extract Fruit Juice

(75) Inventor: Juan Antonio Sanchez De Leon Rodriguez Roda, Valencia (ES)

Correspondence Address: BEEM PATENT LAW FIRM, 53 W. JACKSON BLVD., SUITE 1352, CHICAGO, IL, 60604-3787, US

(73) Assignee: Food Machinery Espanola, S.A., Valencia (ES)

(21) Appl. No.: 11/694,051

(22) Filed: Mar. 30, 2007

(51) Int. Cl. B08B 9/027

(52) U.S. Cl. 15/406

(57) ABSTRACT

Device for cleaning the filter pipes used to extract fruit juice, consisting of a cylindrically shaped tube (1) that runs telescopically through the inside of the filter pipe (2), and some circumferential openings (3) have been made at one end of this interior tube (1) through which previously injected pressurized air is expelled along its entire length The interior tube (1) includes an air inlet (5) that has been provided at one end, and this air inlet (5) is connected to a surrounding chamber (6) with the same configuration as the interior tube (1) and in turn is connected to the openings (3) that this tube has at its other end for cleaning the filter pipe (2).

The object to which the invention protected by this Patent refers is a “Device for cleaning the filter pipes used to extract fruit juice”, which enables the extraction of fruit juice in conventional machines without the need to interrupt the process every once in awhile.

### BACKGROUND

The known procedure for extracting juice from fruit, in particular citric fruits, is to introduce the fruit in a machine that performs this function. To this end, the fruit is channeled and pushed by feed forks to receptacles that receive the fruit, where the fruit is deposited. At the same time, this machine is provided with other receptacles that are located above and are vertically aligned with the receptacles that receive the fruit and that move vertically to trap the fruit.

A cutter then makes a circular incision at the top and bottom of the piece of fruit and, when the upper and lower receptacles compress and squeeze the fruit, the juice exits through a filter pipe located below the receptacles towards a juice collector.

The filter pipe into which the fruit juice enters has holes all along its surface that become obstructed when the fruit pulp gets stuck in them. Therefore the machinery has to be stopped every once in awhile (approximately every 6 or 7 hours) to clean the filter pipe, thus diminishing the performance and autonomy of this machinery.

### DESCRIPTION OF THE INVENTION

The purpose of the invention that comprises the object of this Patent is to eliminate the structural and functional drawbacks inherent in the above described object, and it has been designed and developed in keeping with this preeminent purpose.

1 The device covered by the Patent consists of a cylindrically shaped tube that runs telescopically through the inside of the filter pipe, and some circumferential openings have been made at one end of this interior tube through which previously injected pressurized air is expelled along its entire length.

Although the injection of air is specified, any type of fluid can be injected into the interior tube that will perform the same function and will succeed in keeping all the holes of the filter pipe clean, expelling all the impurities that, during the normal process phase, stick to these holes made along the filter pipe.

In this way, the filter pipe is automatically cleaned, which enables the machine to run uninterruptedly throughout its work cycle. In addition, the performance of this machine is considerably enhanced, with the resulting improvement of its autonomy.

### BRIEF DESCRIPTION OF THE DRAWINGS

To complement the description of the invention and to facilitate interpretation of the structural and functional features of its object, drawings are attached hereto that schematically show a preferential execution of the device for cleaning the filter pipes used to extract fruit juice that comprises the object of this Patent in these drawings:

FIG. 1 shows a section of the unit formed by the filter pipe and the interior tube for cleaning it.

FIG. 2 shows a detail of the filter pipe holes and their connection to the opening where the pressurized air exits.

FIG. 3 shows a section of the interior tube that runs through the inside of the filter pipe.

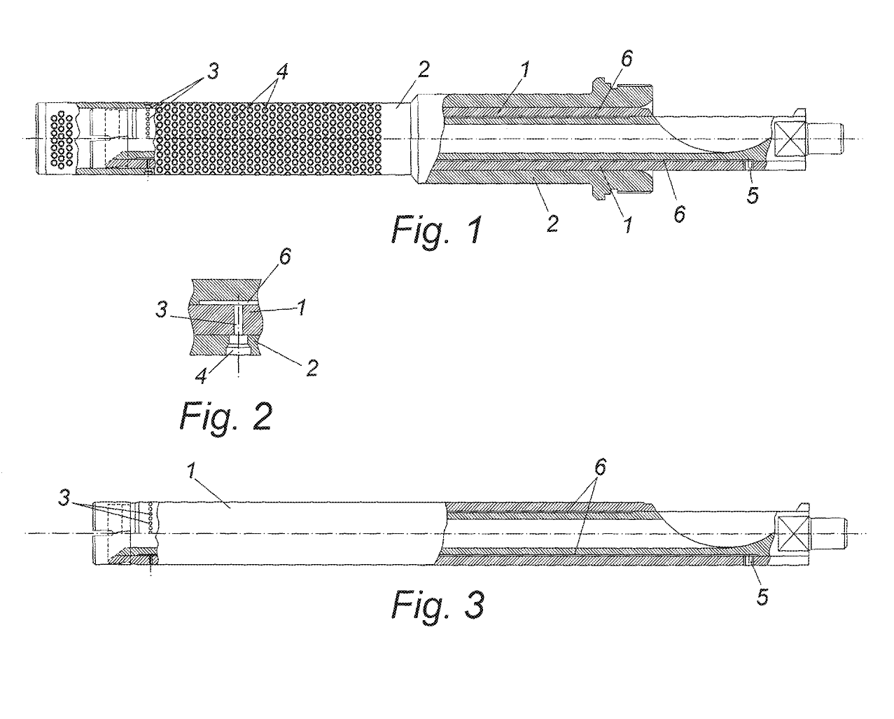

### DESCRIPTION OF A PREFERRED EMBODIMENT

To clearly show the nature and scope of the advantageous application of the device for cleaning filter pipes that comprises the object of the claimed invention, following is a description of its structure with reference to the drawings which, because they represent a preferential execution of this object on an informative basis, should be considered in the broadest sense of the word and not as limitative of the application and the content of the claimed invention.

The device for cleaning the filter pipes used to extract fruit juice is composed of a cylindrically shaped tube (1) that runs telescopically through the inside of the filter pipe (2), and some circumferential openings (3) have been made at one end of this interior tube (1) through which pressurized air is expelled along its entire length, expelling the impurities that stick to the holes (4) made all along the surface of the filter pipe (2).

The pressurized air inlet (5) has been provided at one end of the interior tube (1), in such a way that it is connected to a surrounding chamber (6) with the same configuration as the interior tube (1), and which in turn is connected to the openings (3) that the interior tube (1) has at its other end for cleaning the filter pipe (2).

Although the injection of air is specified, any type of fluid can be injected into the interior tube (1) that will perform the same function and will succeed in keeping all the holes (4) of the filter pipe clean, expelling all the impurities that, during the normal process phase, stick to these holes made along the surface of the filter pipe (2).

What is claimed is:

1. A device for cleaning a filter pipe used to extract fruit juice, comprising:
a cylindrically shaped tube that runs telescopically through the inside of the filter pipe and has circumferential openings at one end of said tube;
wherein pressurized air is expelled along the entire length of said tube.

2. A device for cleaning a filter pipe used to extract fruit juice, according to claim 1, wherein said tube has an air inlet at one end that is connected to a surrounding chamber having the same configuration as said tube and is connected to said openings at the other end for cleaning the filter pipe.
